(19) United States
(12) Patent Application Publication
(10) Pub. No.: US 2014/0085739 A1
(43) Pub. Date: Mar. 27, 2014

(54) Pontoon Mirror Bracket System

(71) Applicant: Protomet Corporation, Oak Ridge, TX (US)

(72) Inventors: Jeff Bohanan, Powell, TN (US); Charles Reeves, Woodlands, TX (US)

(21) Appl. No.: 13/627,539

(22) Filed: Sep. 26, 2012

(51) Int. Cl. G02B 7/198; G02B 7/182

(52) U.S. Cl. CPC G02B 7/198; G02B 7/182
USPC 359/841; 359/871; 359/872

(57) ABSTRACT

A pontoon boat mirror bracket assembly comprising at least one mirror and one mount that attaches to a pontoon boat side rail and positions the mirror for rearward viewing. The mirror bracket may position the mirror in a first position to reflect a rearward view to the boat driver while piloting the boat and a second position for stowing such that a boat cover may be installed onto the boat without removing the mirror bracket assembly.

### CROSS-REFERENCE TO RELATED APPLICATIONS

This application claims the benefit of U.S. Provisional Patent Application No. 61/539,086, filed on Sep. 26, 2011.

### FIELD OF INVENTIVE CONCEPT

The present general inventive concept relates generally to a mirror mounting bracket designed for a pontoon boat.

### BACKGROUND

The boating industry has commonly used mirrors to provide the operator of a boat with a mechanism for viewing persons being towed behind for various sports, such as water skiing, wakeboarding, tubing, and similar activities. Mirrors on boats may also be useful to improve the operator's peripheral view, as well as awareness of other watercraft or other possible objects in the general vicinity.

Mirrors have traditionally been mounted to a windshield or to a wakeboarding tower. Boat mirrors have been generally designed for the needs of the traditional ski or wakeboard boat. These boats generally provide a sturdy windshield or tower as a base for mounting the mirror.

In recent years, pontoon boats have become more powerful and are being designed for water sports activities. Many pontoon boats are now being equipped with tow bars for towing tubers, skiers, and wake boarders.

However, pontoon boats have been neglected with respect to options for installing a boat mirror. Though the first pontoon boat was constructed in 1952, prior to the inventive concept outlined in this document, there have been no pontoon rail mounted options for mirror bracket installation.

### BRIEF SUMMARY

Example embodiments of the present general inventive concept provide a bracket specifically designed to mount to the side rail of a pontoon boat. Some embodiments may be designed to fold such that the boat cover can be installed without removing the bracket from the rail.

### BRIEF DESCRIPTION OF THE FIGURES

The following example embodiments are representative of techniques and structures designed to carry out the objects of the present general inventive concept, but the present general inventive concept is not limited to these example embodiments. In the accompanying drawings and illustrations, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying drawings in which:

FIG. 1 is an isometric view of a mirror bracket assembly mounted to a pontoon boat side rail according to an example embodiment of the general inventive concept;

FIG. 2 is an isometric view of a mirror bracket assembly mounted to a pontoon boat side rail in the folded forward position to provide for installation of boat cover according to an example embodiment of the general inventive concept;

FIG. 3 is an isometric view of a mirror bracket assembly mounted to a pontoon boat side rail in the folded aft position to provide for installation of boat cover according to an example embodiment of the general inventive concept;

FIG. 4 is an isometric view of a clamp-on style mirror bracket assembly according to an example embodiment of the general inventive concept;

FIG. 5 is an isometric view of a clamp-on style mirror bracket assembly shown mounted to a pontoon boat side rail according to an example embodiment of the general inventive concept;

FIG. 6 is an isometric view of a bolt-on style mirror bracket assembly shown mounted to a pontoon boat side rail according to an example embodiment of the general inventive concept;

FIG. 7 is an isometric view of a clamp-on style mirror bracket assembly shown mounted to a pontoon boat side rail in the folded forward position according to an example embodiment of the general inventive concept; and

FIG. 8 is an isometric view of a clamp-on style mirror bracket assembly shown mounted to a pontoon boat side rail in the folded aft position according to an example embodiment of the general inventive concept.

### DETAILED DESCRIPTION

Reference will now be made to the example embodiments of the present general inventive concept, examples of which are illustrated in the accompanying drawings and illustrations. The example embodiments are described herein in order to explain the present general inventive concept by referring to the figures.

The following detailed description may recite various descriptive terms such as horizontal, vertical, top, bottom, upward, downward, left, right, etc., when referring to the exemplary figures, but the present general inventive concept is not limited to any such terms or physical orientations. Such terms are used for convenience of description only, and could be reversed, modified, or interchanged without departing from the broader scope and spirit of the present general inventive concept.

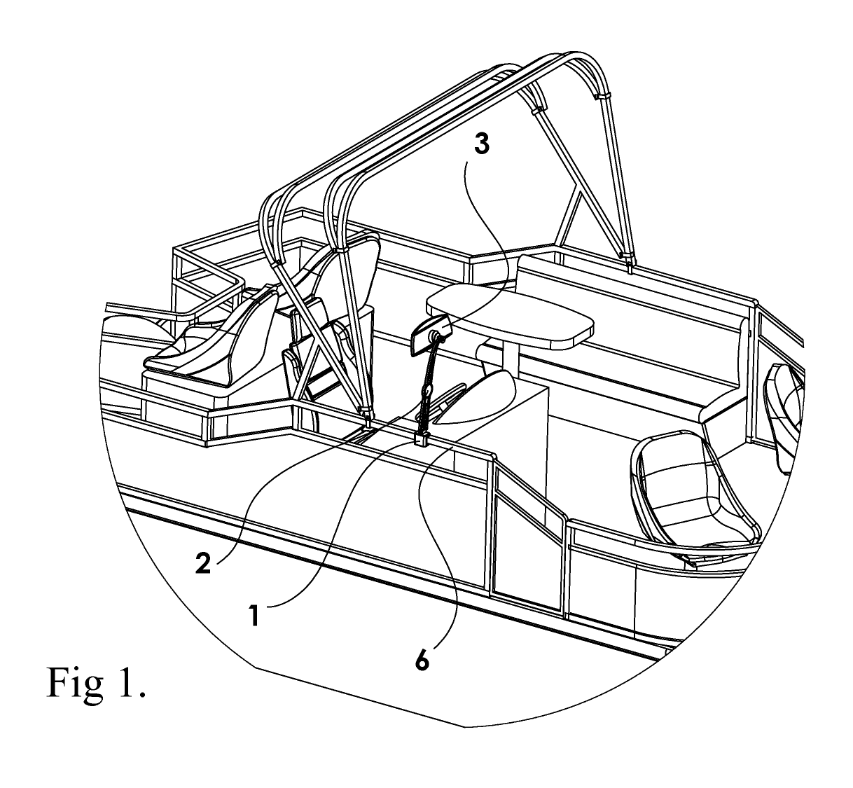

FIG. 1 illustrates an example embodiment of the present general inventive concept. FIG. 1 depicts a mirror and bracket assembly comprised of a Mirror 3, an Arm 2 to position the mirror, and a Stationary Mount 1 secured to the Side Rail 6. The bracket assembly secures and positions the mirror such that the mirror reflects a rearward view for the driver while piloting the boat.

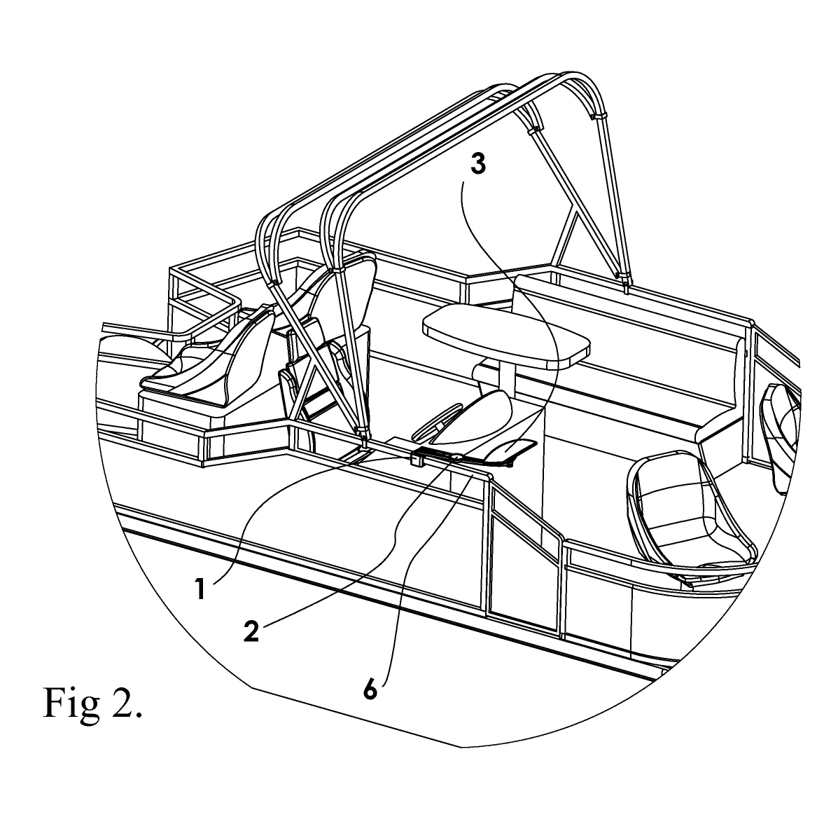

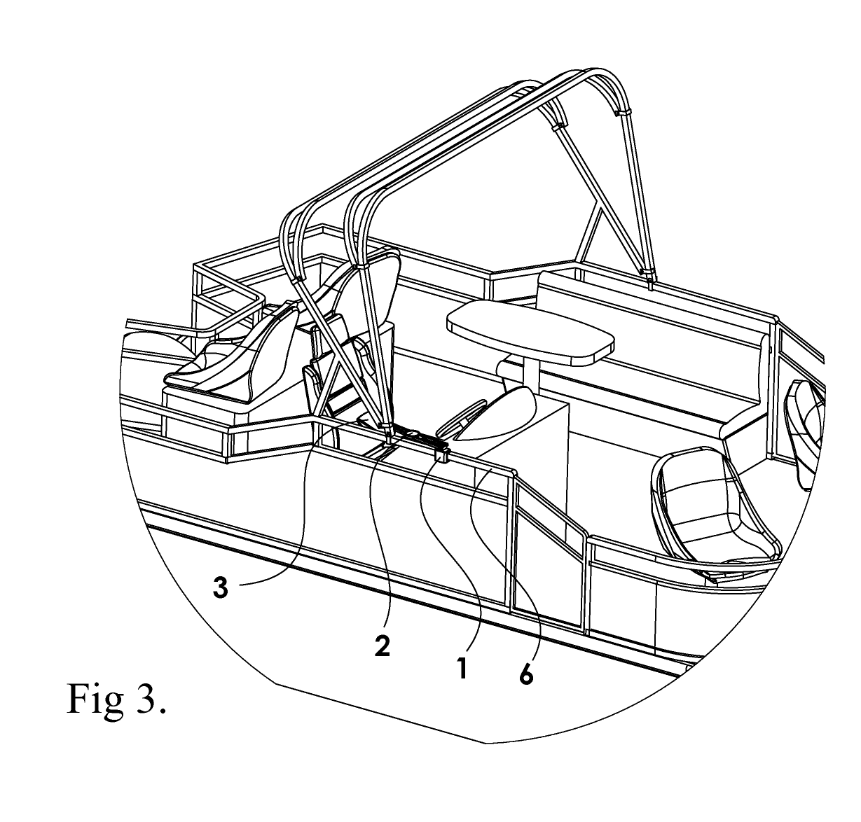

FIGS. 2 and 3 illustrate an example embodiment of the present general inventive concept, whereby the mirror bracket assembly may be folded in the forward or aft position. It is possible to configure the components using sound engineering judgment such that the mirror bracket may be folded forward, aft, inboard or in a plurality of directions provided the vertical member is folded to allow for installation of the boat cover.

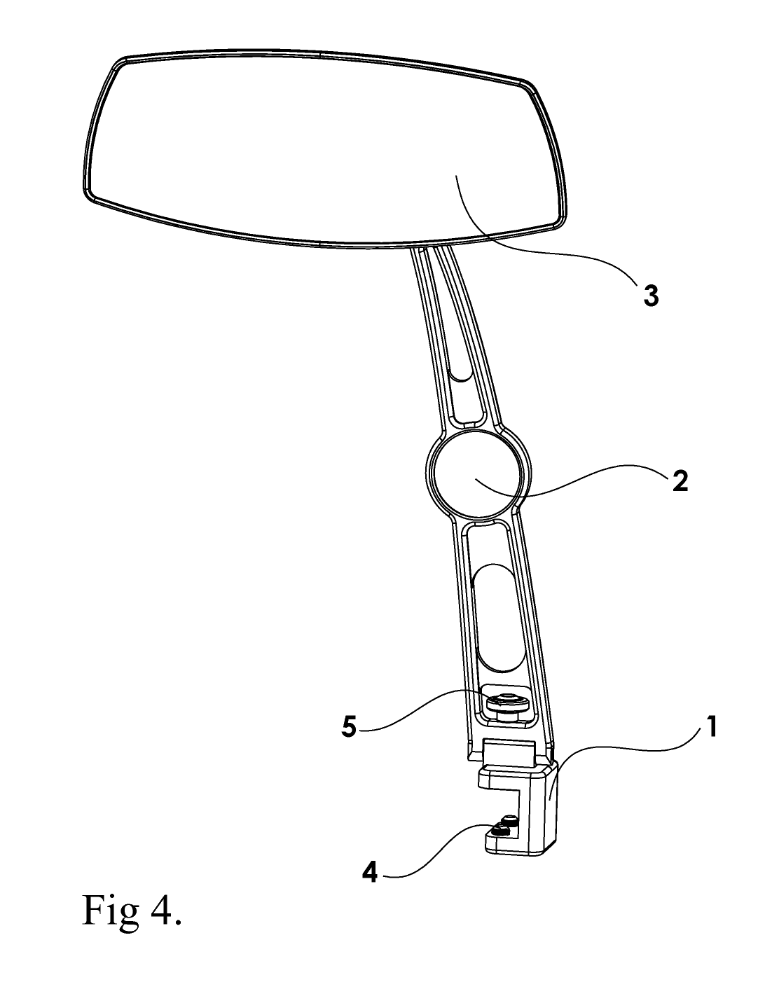

FIG. 4 illustrates an example embodiment of the present general inventive concept. The Stationary Mount 1 is designed to secure to the pontoon boat side rail by tightening one or more Set Screws 4. While this example embodiment depicts a clamp-on Stationary Mount 1, those skilled in the art will appreciate that the Stationary Mount 1 can take a variety of forms and can be designed to attach to the pontoon boat rail using bolts, rivets, adhesives, or any other number of installation options.

The Arm 2 may be pivotably mounted to the Stationary Mount 1 and may be secured in a locked position by the Knob 5. Those skilled in the art will appreciate that the locking may be accomplished with a plurality of locking designs. Those skilled in the art will appreciate that the Stationary Mount 1 and the Arm 2 may be designed such that the Arm 2 does not fold.

Those skilled in the art will appreciate that the Stationary Mount 1 and the Arm 2 may be combined into a single member whereby this single member does not fold but provides for attachment to the pontoon boat side rail on the first end and attachment of the mirror on the second end.

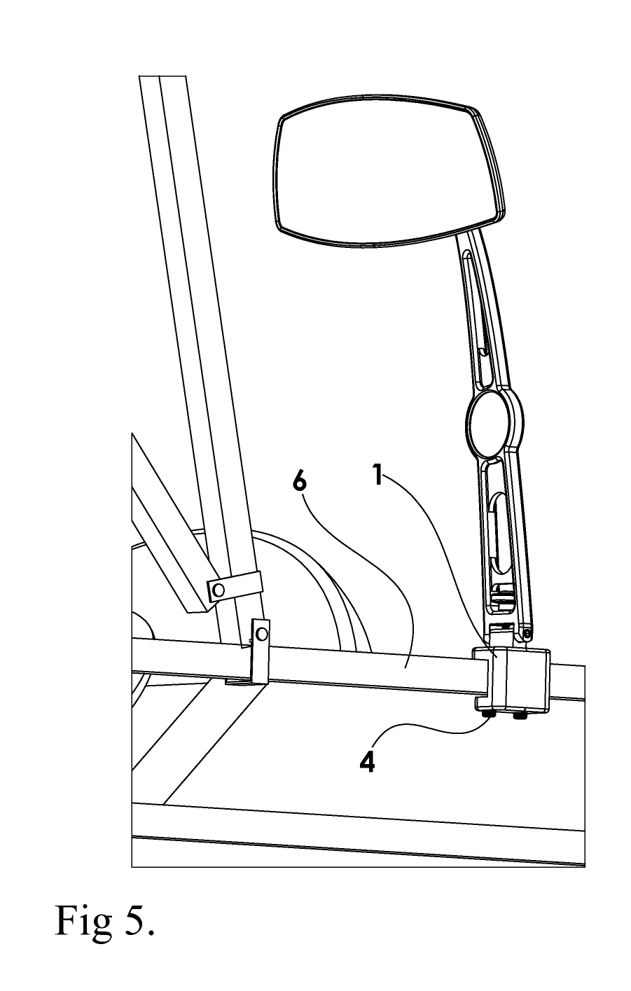

FIG. 5 illustrates an example embodiment of the present general inventive concept installed onto a Side Rail 6 and positioned for the Mirror 3 to reflect a rearward view for the boat driver while piloting the boat. The Stationary Mount 1 is designed to secure to the pontoon boat rail by tightening one or more Set Screws 4. While this example embodiment depicts a clamp-on Stationary Mount 1, those skilled in the art will appreciate that the Stationary Mount 1 can take a variety of forms and can be designed to attach to the Side Rail 6 using bolts, rivets, adhesives, or any plurality of installation options.

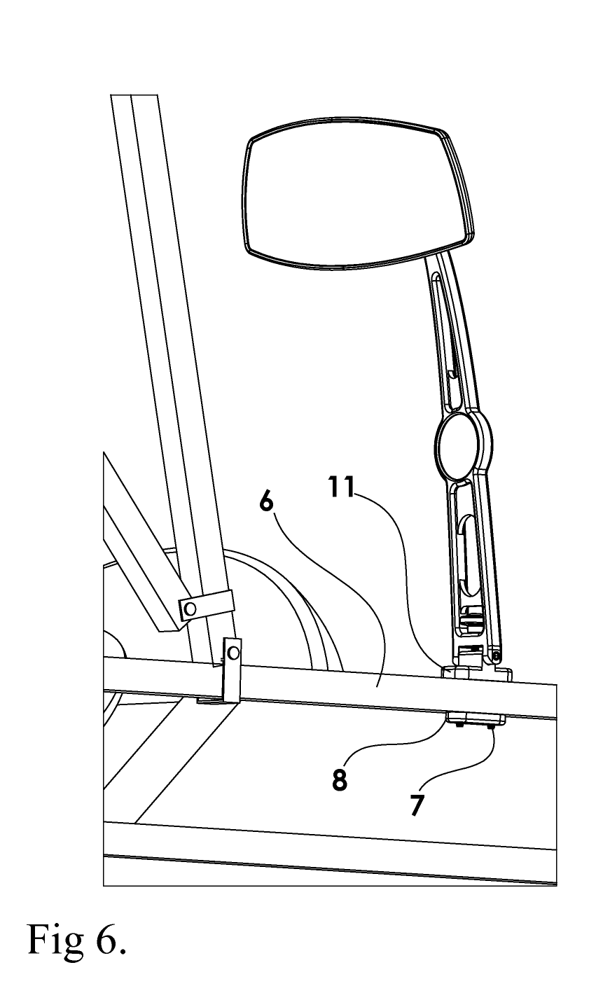

FIG. 6 illustrates an example embodiment of the present general inventive concept installed onto a Side Rail 6 and positioned for the Mirror 3 to reflect a rearward view while driving the boat. The Stationary Mount 11 is designed to secure to the Side Rail 61 by installing one or more Through Bolts 7 and securing with Nut Plate 8. While this example embodiment depicts a bolt-on Stationary Mount 11, those skilled in the art will appreciate that the Stationary Mount 11 can take a variety of forms and can be designed to attach to the Side Rail 6 using bolts, rivets, adhesives, or any plurality of installation options.

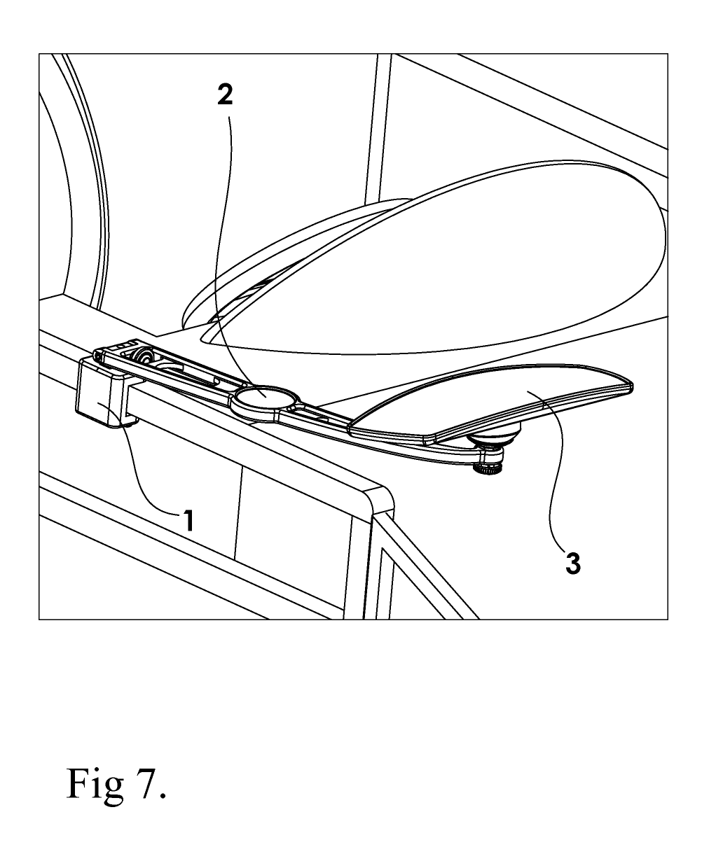

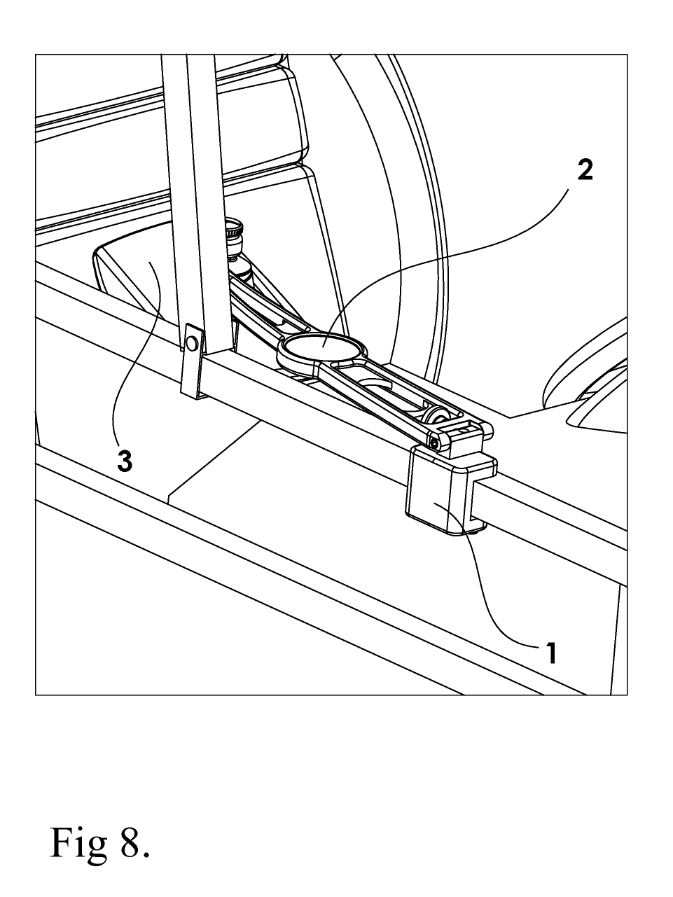

FIGS. 7 and 8 illustrate an example embodiment of the present general inventive concept installed onto a Side Rail 6 and positioned in the folded forward or folded aft positions. Those skilled in the art will appreciate that the pivot axis can be designed to be folded inboard or in a plurality of directions as long as the Arm 2 is positioned to allow for installation of the boat cover.

While the present general inventive concept has been illustrated by description of several example embodiments, it is not the intention of the applicant to restrict or in any way limit the scope of the inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings.

1. A mirror bracket assembly for a pontoon boat, comprising:
at least one mirror; and
at least one bracket that secures to a side rail of the pontoon boat to position the mirror for reflecting a rearward view for a driver of the pontoon boat.

2. The mirror bracket assembly of claim 1, wherein the at least one bracket comprises a substantially vertical arm, and the mirror is mounted to a first end of the substantially vertical arm.

3. The mirror bracket assembly of claim 2, wherein the substantially vertical arm comprises a second end pivotably mounted to a stationary mount.

4. The mirror bracket assembly of claim 3, wherein the stationary mount is bolted, bonded, or clamped to the side rail of the pontoon boat.

5. The mirror bracket assembly of claim 1, wherein the at least one bracket translates from a first position for providing a rearward view for the driver when the pontoon boat is to be operated, to a second position for stowing the mirror bracket assembly to enable a boat cover be installed when the pontoon boat is not to be operated without removing the mirror bracket assembly from the side rail.

6. The mirror bracket assembly of claim 5, wherein the first position is a substantially upright position, and the second position is substantially parallel with the side rail.

7. The mirror bracket assembly of claim 5, wherein the first position is a substantially vertical position, and the second position is a substantially horizontal position.
